(19) United States
(12) Patent Application Publication
(10) Pub. No.: US 2024/0169127 A1
(43) Pub. Date: May 23, 2024

(54) SIMULATION OF CARBON EMISSIONS

(71) Applicant: Altus Power, Inc., Stamford, CT (US)

(72) Inventors: Julia Teresa Sears, Weston, CT (US); Long Pham, Stamford, CT (US); Manojkumar Reddy Pulicherla, Landsdale, PA (US); Abhijit Kiritkumar Parmar, Greenwich, CT (US); Lars Robert Norell, Old Greenwich, CT (US)

(21) Appl. No.: 18/128,096

(22) Filed: Mar. 29, 2023

Related U.S. Application Data
(60) Provisional application No. 63/426,092, filed on Nov. 17, 2022.

(51) Int. Cl. G06F 30/27

(52) U.S. Cl. CPC G06F 30/27; G06F 2113/04

(57) ABSTRACT

A number of models are generated to simulate net carbon emissions for different physical plants. These models can be used in combination with real time data to predict carbon surplus or deficit, and to initiate suitable remedial actions. As a significant advantage, predictive simulations in this context permit physical plant operators to initiate anticipatory carbon transactions well in advance of actual shortfalls or surpluses, and to more consistently manage net carbon emissions over time.

### RELATED APPLICATIONS

This application claims the benefit of U.S. Prov. App. No. 63/426,092 filed on Nov. 17, 2022, the entire content of which is hereby incorporated by reference.

### TECHNICAL FIELD

This disclosure relates to simulation of carbon emissions for facilities with colocated renewable energy sources.

### BACKGROUND

There remains a need for improved simulation of carbon emissions to facilitate advanced planning and management of net carbon emissions.

### SUMMARY

A number of models are generated to simulate net carbon emissions for different physical plants. These models can be used in combination with real time data to predict carbon surplus or deficit, and to initiate suitable remedial actions. As a significant advantage, predictive simulations in this context permit physical plant operators to initiate anticipatory carbon remediations well in advance of actual shortfalls or surpluses, and to more consistently manage net carbon emissions over time.

In one aspect, a predictive analytics system for resource management at a facility with at least one colocated renewable energy source includes computer executable code stored in a non-transitory computer readable medium that, when executing on one or more computing devices, causes the one or more computing devices to perform the steps of: executing a classification engine to identify a building type, the classification engine applying a k-nearest neighbor model configured to categorize a building type based on at least a building size, a building usage, and a location demographic profile; executing a first predictive engine to predict renewable energy generation from the at least one colocated renewable energy source based on meteorological data, the first predictive engine using a predictive model trained to apply result effective variables to estimate an output for a renewable resource type and a physics model to adjust the output according to one or more objective features of the renewable resource type; executing a second predictive engine to predict carbon production from the facility based on the building type, the second predictive engine using a supervised machine learning model trained using historical carbon production data for the building type and temporally corresponding historical meteorological conditions; receiving a request for a carbon offset estimate for the facility over an interval; retrieving meteorological prediction data for the interval from one or more remotely hosted meteorological services; determining the building type for the facility with the classification engine; simulating a renewable energy output for the facility over the interval with the first predictive engine based on the meteorological prediction data for the interval; simulating a carbon output for the facility over the interval with the second predictive engine based on the building type from the classification engine and the meteorological prediction data for the interval; calculating the carbon offset estimate based on a difference between the renewable energy output and the carbon output over the interval; and taking an action based on the carbon offset estimate.

The system may further include code that causes the one or more computing devices to perform the steps of comparing the carbon offset estimate for the facility to a carbon target for the facility, and generating a user recommendation based on a difference between the carbon offset estimate and the carbon target. The system may also or instead include code that causes the one or more computing devices to perform the steps of acquiring data from one or more sensors at the facility to monitor a current energy generation from the at least one colocated renewable energy source, and updating the carbon offset estimate for the interval based on the current energy generation. The system may also or instead include code that causes the one or more computing devices to perform the steps of acquiring data from one or more sensors at the facility to monitor a current electrical consumption at the facility, and updating the offset estimate for the interval based on the current electrical consumption. The colocated renewable energy source may include at least one of a solar power source or a wind turbine.

In another aspect, a method for predictive analysis of carbon budgets for a facility with at least one colocated renewable energy source, as described herein, includes: receiving a request for a carbon offset estimate for the facility over an interval; retrieving meteorological prediction data for the interval from one or more remotely hosted meteorological services; processing building data for the facility with a classification engine to determine the building type for the facility, where the classification engine applies a k-nearest neighbor model configured to categorize the building type based on the building data, and wherein the building data includes at least a building size, a building usage, and a location demographic profile; simulating a renewable energy generation from the at least one colocated renewable energy source with a first predictive engine, the first predictive engine calculating energy generation using (a) a predictive model trained to estimate an output for a renewable resource type based on one or more result effective variables and (b) a physics model to adjust an output of the predictive model according to one or more objective features of the renewable resource type; simulating a carbon production from the facility with a second predictive engine, the second predictive engine calculating the carbon production using the meteorological prediction data for the interval and a supervised machine learning model trained using historical carbon production data for the building type and temporally corresponding historical meteorological conditions; calculating the carbon offset estimate based on a difference between the renewable energy output and the carbon output over the interval; and taking an action based on the carbon offset estimate.

The method may include comparing the carbon offset estimate for the facility to a carbon target for the facility. The method may include displaying a comparison of the carbon offset estimate to the carbon target for the facility in a user interface. The method may include instrumenting the facility with a first one or more sensors to monitor a current energy generation from the at least one colocated renewable energy source at the facility, and instrumenting the facility with a second one or more sensors to monitor a current electrical consumption at the facility. The method may include updating the carbon offset estimate for the interval based on data from the first one or more sensors and the second one or more sensors during the interval. The method may include presenting the updated carbon offset estimate to a user. The method may include normalizing and aggregating sensor data from the second one or more sensors for use in at least one of peer benchmarking and machine learning. The second one or more sensors may include one or more device monitors within the facility. Taking an action may include transmitting a request for a responsive action from a user to a difference between the carbon offset estimate and a carbon target for the facility during the interval. Taking an action may include generating an automated action to reduce the carbon offset estimate. The one or more result effective variables for the predictive model may include at least one variable from the meteorological prediction data.

In another aspect, a system for predictive analysis of carbon budget data based on third-party meteorological services and a local facility classification engine, as described herein, includes a physical site including a building, a renewable energy source, and a plurality of sensors for monitoring energy usage at the building. The system may also include a database storing data acquired from the plurality of sensors, and a server hosting renewable energy management resources for the physical site. The renewable energy management resources may include a programmatic interface to a remote service configured to provide meteorological prediction data, a classification engine configured to categorize a building type using a k-nearest neighbor model based on objective building parameters, a first predictive engine configured to simulate renewable energy generation from the renewable energy source using a predictive model trained to apply result effective variables to estimate an output for a renewable resource type and a physics model to adjust the output according to one or more objective features of the renewable resource type, and a second predictive engine configured to simulate a carbon production from the physical site based on at least the meteorological prediction data and the building type, the second predictive engine using a supervised machine learning model trained using historical carbon production data for the building type and temporally corresponding historical meteorological conditions. The server may be configured to receive, in a user interface rendered by the server, an input of an interval for processing carbon data for the physical site, retrieve, through the programmatic interface to the remote service, the meteorological prediction data for the interval identified in the input, determine, with the classification engine, the building type associated with the physical site, calculate, with the first predictive engine, an expected output during the interval from the renewable energy source colocated with the physical site, calculate, with the second predictive engine, an expected carbon production during the interval from the physical site, and initiate, in response to a disparity between the expected output of the renewable source and the expected carbon production of the physical site, a responsive action for the physical site.

The responsive action may include an automatic action by the server to reduce the disparity. The responsive action may include transmitting a notification concerning the disparity to an administrator. The renewable energy source may include at least one of a solar power source and a wind turbine.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 is a diagram of a computing device for use in the methods and systems described herein.

FIG. 2 depicts a networked environment for managing resources.

FIG. 3 illustrates a system for simulation and management of carbon resources.

FIG. 4 illustrates a predictive analytics process for carbon resource management.

FIG. 5 illustrates a process for generating a classification engine.

FIG. 6 illustrates a process for generating a predictive engine.

FIG. 7 illustrates a process for generating a predictive engine.

### DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better describe the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

To provide an overall understanding of the disclosure, certain illustrative implementations will now be described, including systems, methods, and devices for simulation of carbon emissions for facilities with colocated renewable energy sources. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof. Generally, the computerized systems described herein may comprise one or more engines, platforms, modules, compute instances, or the like, which may include a processing device or devices, such as a computer, microprocessor, logic device, or other device or processor that is configured with hardware, firmware, and/or software to carry out one or more of the computerized methods described herein.

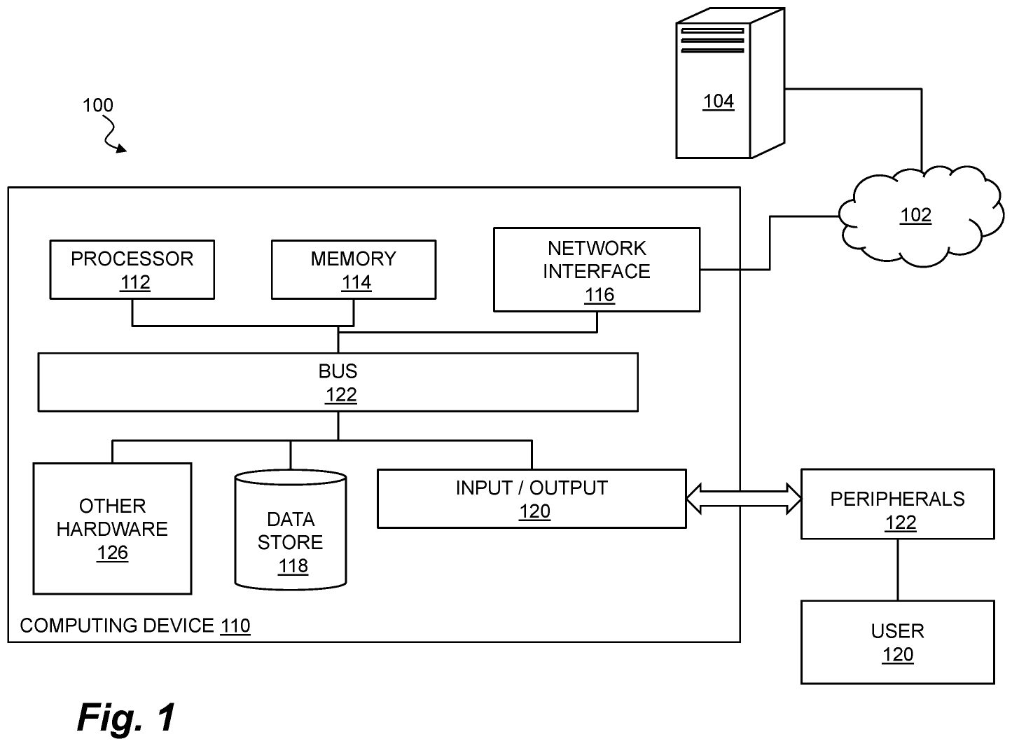

FIG. 1 is a diagram of a computer system 100 for use in the methods and systems described herein. In general, the device 100 of FIG. 1 may be used to implement a website, a central computing platform, a transaction engine, an external data source, or any of the other platforms, entities, or computing devices or the like described herein. The computer system 100 may also or instead be configured by computer executable code stored in a memory and executable by one or more processors to perform the various steps of methods and processes described herein.

The computer system 100 may include a computing device 110 connected to a network 102, e.g., through an external device 104. The computing device 110 may be or include any type of network endpoint or endpoints as described herein. For example, the computing device 110 may include a desktop computer workstation. The computing device 110 may also or instead be any other device that has a processor and communicates over a network 102, including without limitation a laptop computer, a desktop computer, a personal digital assistant, a tablet, a mobile phone, a television, a set top box, a wearable computer, and so forth. The computing device 110 may also or instead include a server, or it may be disposed on a server or within a virtual or physical server farm. In certain aspects, the computing device 110 may be implemented using hardware (e.g., in a desktop computer), software (e.g., in a virtual machine or the like), or a combination of software and hardware (e.g., with programs executing on the desktop computer), and the computing device 110 may be a standalone device, a device integrated into another entity or device, a platform distributed across multiple entities, or a virtualized device executing in a virtualization environment.

The network 102 may include any network or combination of networks, such as one or more data networks or internetworks suitable for communicating data and control information among participants in the computer system 100. The network 102 may include public networks such as the Internet, private networks, and telecommunications networks such as the Public Switched Telephone Network or cellular networks using third generation cellular technology (e.g., 3G or IMT-2000), fourth/fifth generation cellular technology (e.g., 4G, LTE, MT-Advanced, E-UTRA, 5G, etc.) or WiMax-Advanced (IEEE 802.16m)) and/or other technologies, as well as any of a variety of corporate area, metropolitan area, campus, or other local area networks or enterprise networks, along with any switches, routers, hubs, gateways, and the like that might be used to carry data among participants in the computer system 100. The network 102 may also include a combination of data networks, and need not be limited to a strictly public or private network.

The external device 104 may be any computer or other remote resource that connects to the computing device 110 through the network 102. This may include threat management resources such as any of those contemplated above, gateways or other network devices, remote servers or the like containing content requested by the computing device 110, a network storage device or resource, a device hosting content, or any other resource or device that might connect to the computing device 110 through the network 102.

The computing device 110 may include a processor 112, a memory 114, a network interface 116, a data store 118, and one or more input/output devices 120. The computing device 110 may further include or be in communication with one or more peripherals 122 and other external input/output devices 124.

The processor 112 may be any as described herein, and in general may be capable of processing instructions for execution within the computing device 110 or computer system 100. In one aspect, the processor 112 may be capable of processing instructions stored in the memory 114 or on the data store 118.

The memory 114 may store information within the computing device 110 or computer system 100. The memory 114 may include any volatile or non-volatile memory or other computer-readable medium, including without limitation a Random-Access Memory (RAM), a flash memory, a Read Only Memory (ROM), a Programmable Read-only Memory (PROM), an Erasable PROM (EPROM), registers, and so forth. The memory 114 may store program instructions, program data, executables, and other software and data useful for controlling operation of the computing device 110 and configuring the computing device 110 to perform functions for a user. While a single memory 114 is depicted, it will be understood that any number of memories may be usefully incorporated into the computing device 110. For example, a first memory may provide non-volatile storage such as a disk drive for permanent or long-term storage of files and code even when the computing device 110 is powered down, and a second memory such as a random-access memory may provide volatile (but higher speed) memory for storing instructions and data for executing processes.

The network interface 116 may include any hardware and/or software for connecting the computing device 110 in a communicating relationship with other resources through the network 102. This may include connections to resources such as remote resources accessible through the Internet, as well as local resources available using short range communications protocols using, e.g., physical connections (e.g., Ethernet), radio frequency communications (e.g., WiFi or Bluetooth), optical communications, (e.g., fiber optics, infrared, or the like), ultrasonic communications, or any combination of these or other media that might be used to carry data between the computing device 110 and other devices. The network interface 116 may, for example, include a router, a modem, a network card, an infrared transceiver, a radio frequency (RF) transceiver, a near field communications interface, a radio-frequency identification (RFID) tag reader, or any other data reading or writing resource or the like. More generally, the network interface 116 may include any combination of hardware and software suitable for coupling the components of the computing device 110 to other platforms, computing or communications resources, and so forth.

The data store 118 may be any internal memory store providing a computer-readable medium such as a disk drive, an optical drive, a magnetic drive, a flash drive, memory card, or other device capable of providing mass storage for the computing device 110. The data store 118 may store computer readable instructions, data structures, program modules, and other data for the computing device 110 or computer system 100 in a non-volatile form for subsequent retrieval and use. The data store 118 may store computer executable code for an operating system, application programs, and other program modules, software objects, libraries, executables, and the like the like. The data store 118 may also store program data, databases, files, media, and so forth.

The input/output interface 120 may support input from and output to other devices that might couple to the computing device 110. This may, for example, include serial ports (e.g., RS-232 ports), universal serial bus (USB) ports, optical ports, Ethernet ports, telephone ports, audio jacks, component audio/video inputs, HDMI ports, and so forth, any of which might be used to form wired connections to other local devices. This may also or instead include an infrared interface, RF interface, magnetic card reader, or other input/output system for coupling in a communicating relationship with other local devices.

The peripherals 122 may include any device or combination of devices used to provide information to or receive information from the computing device 110. This may include human input/output (I/O) devices such as a keyboard, a mouse, a mouse pad, a track ball, a joystick, a microphone, a foot pedal, a camera, a touch screen, a scanner, or other device that might be employed by the user 130 to provide input to the computing device 110. This may also or instead include a display, a speaker, a printer, a projector, a headset, or any other audiovisual device for presenting information to a user or otherwise providing machine-usable or human-usable output from the computing device 110. The peripheral 122 may also or instead include a digital signal processing device, an actuator, or other device to support control of or communication with other devices or components.

Other hardware 126 may be incorporated into the computing device 110 such as a co-processor, a digital signal processing system, a math co-processor, a graphics engine, a video driver, and so forth. The other hardware 126 may also or instead include expanded input/output ports, extra memory, additional drives (e.g., a DVD drive or other accessory), and so forth.

A bus 132 or combination of busses may serve as an electromechanical platform for interconnecting components of the computing device 110 such as the processor 112, memory 114, network interface 116, other hardware 126, data store 118, and input/output interface 120. As shown in the figure, each of the components of the computing device 110 may be interconnected using a system bus 132 or other communication mechanism for communicating information.

Methods and systems described herein can be realized using the processor 112 of the computer system 100 to execute one or more sequences of instructions contained in the memory 114 to perform predetermined tasks. In embodiments, the computing device 110 may be deployed as a number of parallel processors synchronized to execute code together for improved performance, or the computing device 110 may be realized in a virtualized environment where software on a hypervisor or other virtualization management facility emulates components of the computing device 110 as appropriate to reproduce some or all of the functions of a hardware instantiation of the computing device 110.

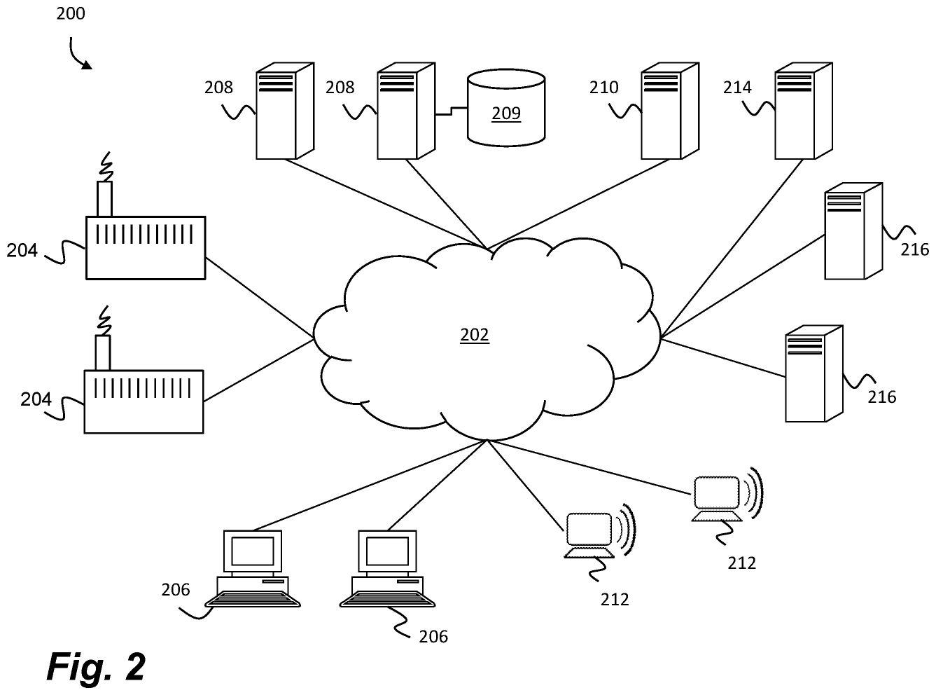

FIG. 2 depicts a networked environment for managing resources. In general, the environment 200 may include a data network 202 interconnecting a plurality of participating devices in a communicating relationship. The participating devices may include or be deployed on any of the computing devices or other resources described herein, and may, for example, include any number of facilities 204 (also referred to interchangeably herein as “buildings,” “physical premises,” or the like), client devices 206, servers 208, content sources 210, mobile devices 212, and other resources 216.

The data network 202 may be any network(s) or internetwork(s) suitable for communicating data and control information among participants in the environment 200. This may include public networks such as the Internet, private networks, telecommunications networks such as the Public Switched Telephone Network or cellular networks using third generation (e.g., 2G or IMT-2000), fourth generation (e.g., LTE (E-UTRA) or WiMax-Advanced (IEEE 802.16m), as well as any of a variety of corporate area or local area networks and other switches, routers, hubs, gateways, and the like that might be used to carry data among participants in the environment 200.

The facilities 204 may include any commercial, residential, public, recreational, or other physical infrastructure or the like that uses, or that may consider using, renewable energy to lower costs, manage carbon footprint, satisfy ESG (Environmental, Social, Governance) demands or similar, or otherwise meet corporate objectives or the like. Each premises 204 may, for example, include a building or group of buildings and the like for office, industrial, residential, retail, medical, entertainment, or other commercial use. The premises 204 may also or instead include a farm or other agricultural concern, a carport, a stadium, an electrical vehicle charging facility, and so forth. Each facility 204 may include local monitoring systems including sensors, building management platforms, and the like, and may include one or more connections to the data network 202 for transceiving data and control information. As described herein, each facility 204 may include a colocated renewable energy system and/or may be considering the addition of a renewable energy system.

Client devices 206 may in general be devices within the environment 200 operated by users to interact with other elements of the environment 200. This may include desktop computers, laptop computers, network computers, tablets, or any other computing device that can participate in the environment 200 as contemplated herein. Each client device 206 generally provides a user interface, which may include a graphical user interface and/or text or command line interface for interaction with the facilities 204 and other network resources. The user interface may be maintained by a locally executing application on one of the client devices 206 that receives data and status information from, e.g., the facilities 204 and servers 208 concerning weather predictions, carbon usage, sensor data from the facilities 204, and so forth, and creates a suitable display on the client device 206 for user interaction. In other embodiments, the user interface may be remotely served and presented on one of the client devices 206, such as where another resource includes a web server that provides information through one or more web pages or the like that can be displayed within a web browser or similar client executing on one of the client devices 206.

The servers 208 may include data storage, a network interface, and a processor or other processing circuitry. The servers 208 may support various functions described herein including, without limitation, generating weather forecasts, storing weather data, storing models for simulating energy usage and renewable energy output, and so forth.

The content sources 210 may include any sources of content for use in the methods and systems described herein. This may, for example, include historical weather data, carbon pricing data, and so forth.

One or more web servers 214 may provide web-based access to and from any of the other participants or resources in the environment 200. While depicted as a separate network entity, it will be appreciated that a web server 214 may be logically or physically associated with one of the other network elements described herein, and may, for example, provide a user interface for web access to one of the servers 208, the content sources 210, the facilities 204, and so forth in a manner that permits user interaction through the data network 202, e.g., from a client device 206 or mobile device 212.

The mobile devices 212 may be any form of mobile device, such as any wireless, battery-powered device, that might be used to interact with the networked environment 200. The mobile devices 212 may, for example, include laptop computers, tablets, thin client network computers, portable digital assistants, messaging devices, cellular phones, smart phones, portable media or entertainment devices, and so forth. In general, mobile devices 212 may be operated by users for a variety of user-oriented functions such as monitoring activity at the facilities 204, reviewing forecast data, and so forth.

The other resources 216 may include any other software or hardware resources that may be usefully employed in the systems and methods described herein. For example, the other resources 216 may include payment processing servers or platforms used to authorize payments, or a commercial database or the like of ESG or environmental data. As another example, the other resources 216 may include a host for carbon transactions, or a distributed ledger hosted on a number of participating devices and used to exchange carbon data and carbon transactions. In another aspect, the other resources 216 may include a cloud computing platform, cloud-based data storage, identity management platform, virtualization platform, or other resource or combination of resources suitable for providing a networked computing platform for the systems and methods described herein.

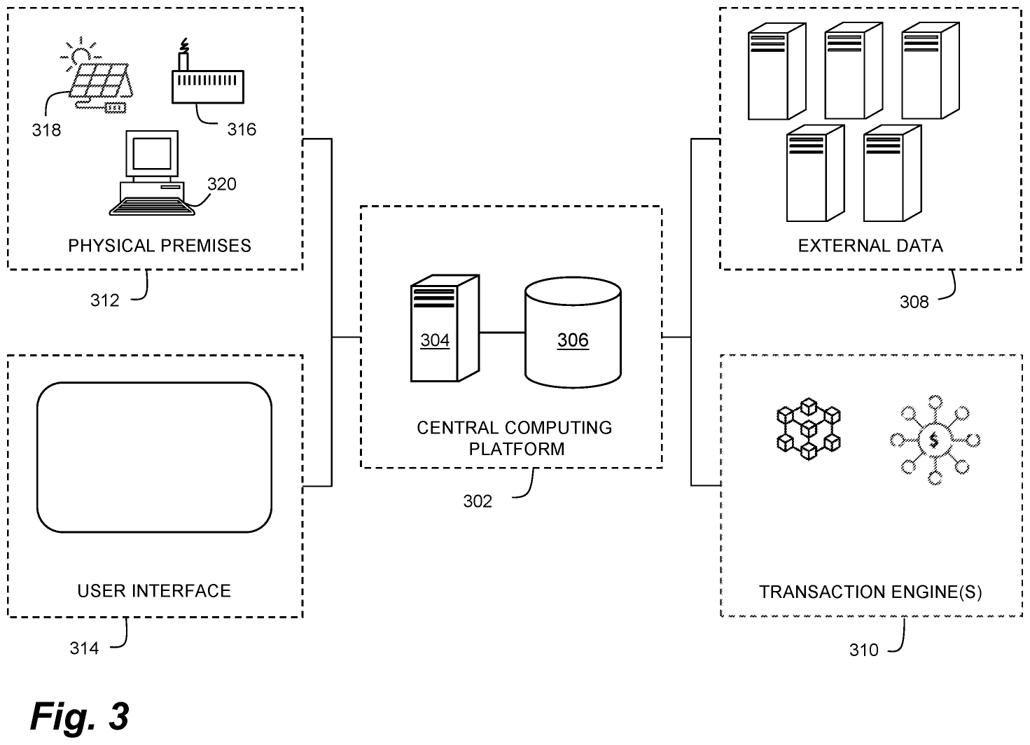

FIG. 3 illustrates a system for simulation and management of carbon resources. The system 300 may, for example, include a central computing platform 302 with a computing facility 304 and a data store 306 for models, simulations, and the like. The system 300 may also include one or more external data sources 308, one or more remote resources 310, and facilities 312. In general, the central computing platform 302 may host or otherwise support a user interface 314 providing a user interface for interaction with data, models, and external resources that are monitored, controlled, managed, or used by the central computing platform 302.

The central computing platform 302 may be deployed, e.g., in a cloud computing environment, local computing infrastructure, or some combination of these, or any other computing resource or combination of computing resources suitable for supporting the methods and systems described herein.

In one aspect, the central computing platform 302 may host a simulation platform as described herein, along with other resources for using the simulation platform to manage a carbon budget for the facilities 312 as described herein. In this capacity, the central computing platform 302 may receive and process data from other resources (such as the external data sources 308), and use this data to simulate operation of the facilities 312 in response to forecast data. The central computing platform 302 may also manage interactions as needed with other external resources such as one or more remote resources 310 configured to remediate anticipated carbon output exceeding predetermined thresholds. The central computing platform 302 may generally provide an interface such as the user interface 314 for managing models, data sources, user accounts, and the like. It will be understood that, while the central computing platform 302 may generally provide a central hub for data acquisition, processing, management, and responsive actions as described herein, the central computing platform 302 may be realized as any number of distributed, physical, and/or cloud-based computing resources, which may be located on a local network at the facilities 312, distributed across multiple physical locations, implemented in a cloud or virtualized computing environment, or any suitable combination of these.

The central computing platform 302 may also provide any suitable tools for monitoring activity at the facilities 312 receiving and storing sensor data related to renewable energy generation, energy consumption, and the like. This may also or instead include tracking any sensor data from devices or sensors at the facilities 312. For example, this may include data for ambient conditions such as temperature, light, precipitation, humidity, and so forth. This may also include operational data for the facilities 312 such as utility usage (electricity, water, etc.), manufacturing activity, occupancy rates, and so forth. The central computer platform 302 may also provide tools for user interaction with sensors and equipment at the facilities 312, as well tools for managing network-connected hardware on the facilities 312, and any other tools or resources useful for managing the facilities 312 as contemplated herein.

The computing facility 304 may include any processor, collection of processors, virtual processors, cloud computing resources, or combination of the foregoing useful for implementing the methods and systems described herein. In one aspect, the computing facility 304 may be a cloud computing facility or other computing resource(s) coupled in a communicating relationship with resources of the facilities 312, the external data sources 308, the transaction engine(s) 310, and so forth.

The data store 306, which may include a local data store coupled to the computing facility 304, a cloud data store, or some combination of these. The data store 306 may also or instead include storage resources on the facilities 312, which may, e.g., store user data, receive data and commands from the central computing platform 302, and so forth. The data store 306 may store, e.g., user profile data, building information, IoT data, building sensor data, renewable energy production data, and the like. In addition to raw data, the data store 306 may also store pre-processed data, such as feature vectors that have been extracted from the raw data, which may be used as inputs to predictive machine learning models, simulations, and the like.

The data store 306 may also or instead store models, schemas, or the like for interpreting and using data from such sources. For example, the data store may store simulation models, simulation parameters, simulation data, and the like, including locally generated data and data from external data sources 308. In one aspect, the data store 306 may store one or more model architectures that define the structure of machine learning models, typically including aspects such as the types and number of layers, activation functions, and other components. The data store 306 may also store learned parameters for a model, e.g., the values that the machine learning model has learned from training data. These parameters may be updated during the training process to optimize the model's performance on a specific task, learn additional tasks, and so forth. The learned parameters are typically stored separately from the model architecture in any suitable format such as a NumPy array (for a PyTorch model) or a TensorFlow checkpoint file (for a TensorFlow model).

The external data sources 308 may include any external data sources providing data to the system, such as forecast data, renewable energy resource modeling and performance data, and so forth. In general, the external data sources 308 may be coupled to the central computing platform 302 through a programmatic interface that supports query and retrieval of data such as meteorological prediction data and the like useful for running simulations, or for otherwise creating, testing, and executing simulation models as contemplated herein.

The transaction engines 310 may include any transaction engine(s) or the like operated by third parties (or distributed/de-centralized using, e.g., Web 3.0 technologies or the like) and suitable for carbon remediation transactions that are suggested by the central computing platform 302 based on predictive modeling. The central computing platform 302 may engage these transaction engines 310 automatically in order to remediate carbon imbalances, or transmit corresponding transaction recommendations to a user, e.g., when simulation results exceed carbon thresholds by a predetermined amount such that remediation is necessary or helpful for achieving user targets.

In general, the facilities 312 may include infrastructure 316 such as one or more commercial buildings, residential buildings, manufacturing facilities, and the like, along with one or more colocated renewable energy resources 318 and local computing resources 320. The renewable energy resource(s) 318 may include any of the renewable energy resources described herein. The local computing resources 320 may generally provide local network and computing infrastructure for the facilities 312, as well as connectivity to the central computing platform 302 as generally described herein.

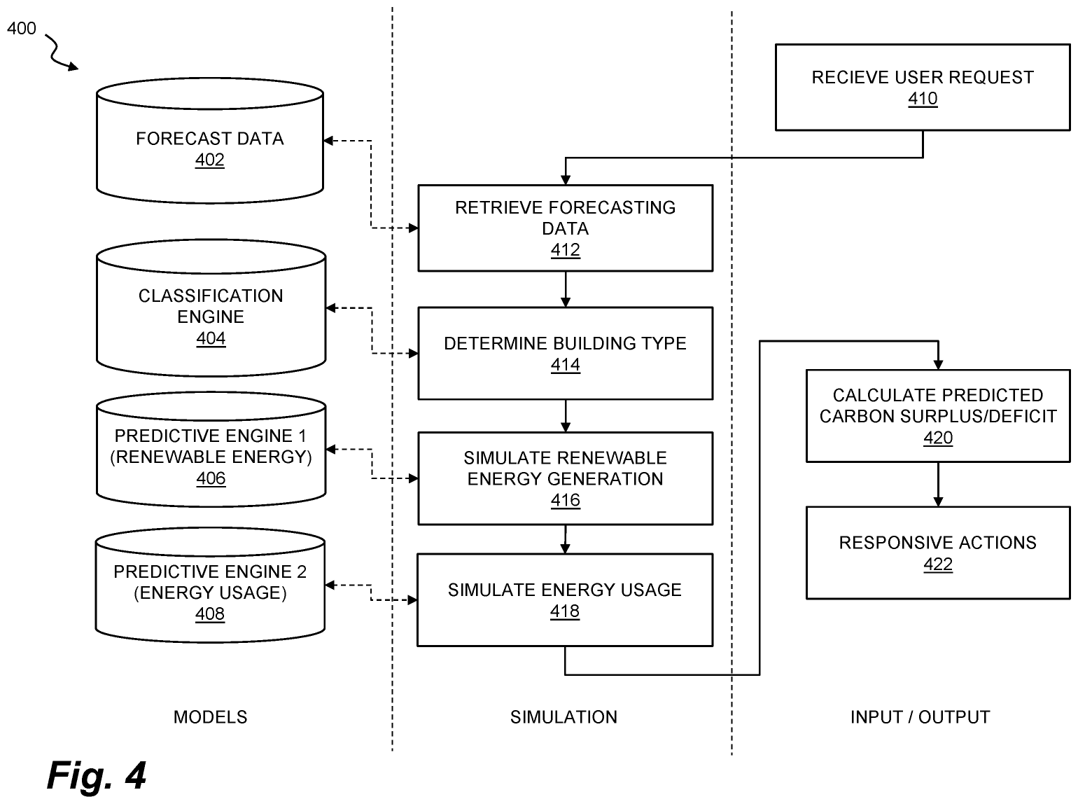

FIG. 4 illustrates a predictive analytics process for carbon resource management. In general, the method 400 may use a number of data sources and simulation models to predict carbon performance of a facility with a colocated renewable energy resource. The method 400 may advantageously use forecast data 402 or other meteorological prediction data such as meteorological data from third party weather forecasting resources such as the National Weather Service's Global Forecast System (GFS), the North American Mesoscale Forecast System (NAM), the High Resolution Rapid Refresh (HRRR), the Integrated Forecast System (IFS) by the European Center for Medium-Range Weather Forecast (ECMWF), and so forth. More generally, any live or synthesized data sources that can provide data to the central computing platform 302 on an as-available basis may be used as external data sources 308 providing inputs for modeling and simulation as contemplated herein.

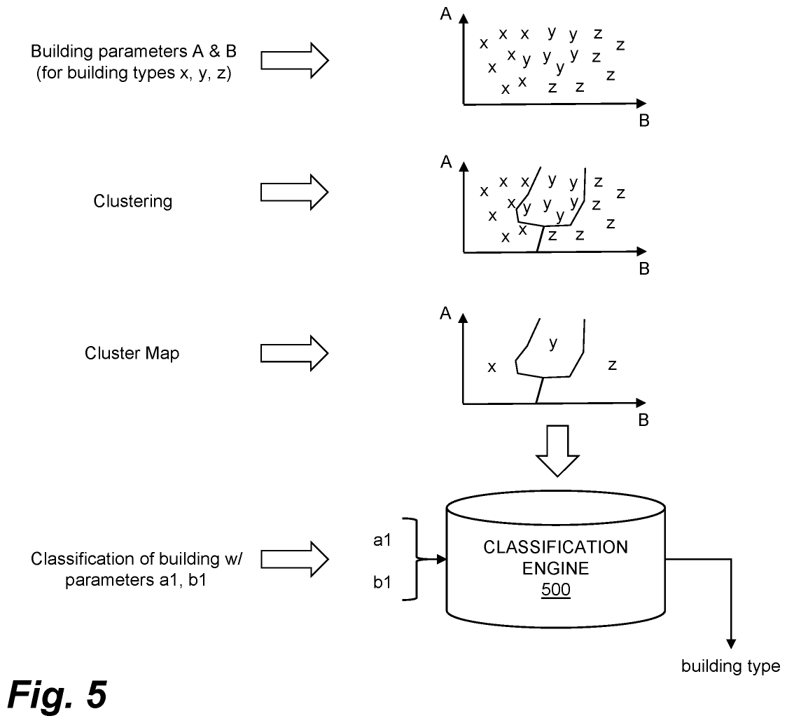

In one aspect, the method 400 may include generating, storing, and/or executing a classification engine 404 to identify a building type or otherwise classify facilities for purposes of selecting suitable simulation models and parameters. In one aspect, the classification engine 404 may apply a k-nearest neighbor model configured to categorize a building type based on at least a building size, a building usage, and a location demographic profile. More generally, any technique or combination of techniques suitable for classifying infrastructure based on objective parameters may be used as the classification engine 404 described herein. The classification engine 404 may execute on the central computing platform, or any other computing device(s) or computing resource(s) described herein. It will be understood that the classification engine 404 may be executing continuously, or may be launched and executed in response to specific user requests, or some combination of these. The classification engine 404 may also be periodically updated on any useful schedule as new information becomes available. A suitable classification engine 404 is described by way of non-limiting example with reference to FIG. 5 below.

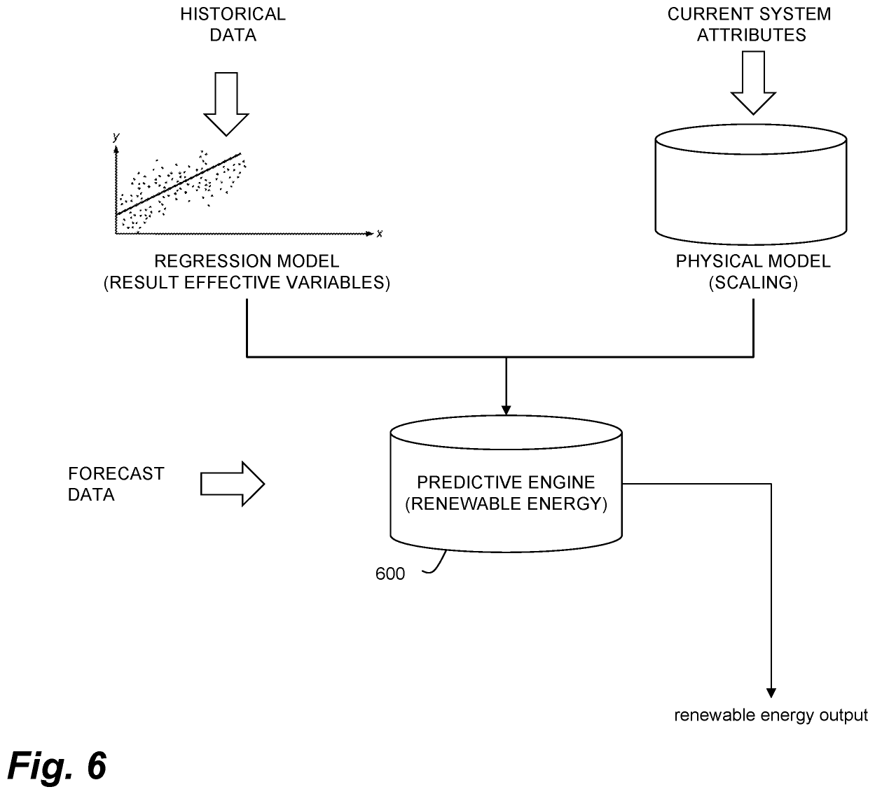

In another aspect, the method 400 may include generating, storing, and/or executing a first predictive engine 406 to simulate renewable energy generation. In general, the first predictive engine 406 may be configured (e.g., by computer executable code executing on the central computing platform) to predict renewable energy generation from a (colocated) renewable energy resource based on, e.g., the forecast data 402 from third party sources, along with any suitable parameters or other descriptive data for the renewable energy resource. In one aspect, this may include executing the first predictive engine 406 to predict renewable energy generation from at least one colocated renewable energy source for the facilities based on meteorological data. The first predictive engine may, for example, use a predictive model trained to apply result effective variables to estimate an output for a renewable resource type, along with a physics model to adjust the output according to one or more objective features of the renewable resource type. In this context, the result effective variables may include one or more variables from meteorological prediction data, or any variable(s) correlated to renewable energy generation as described herein. The first predictive engine 406 may be periodically updated on any useful schedule as new information becomes available. A suitable first predictive engine 406 is described by way of non-limiting example with reference to FIG. 6 below.

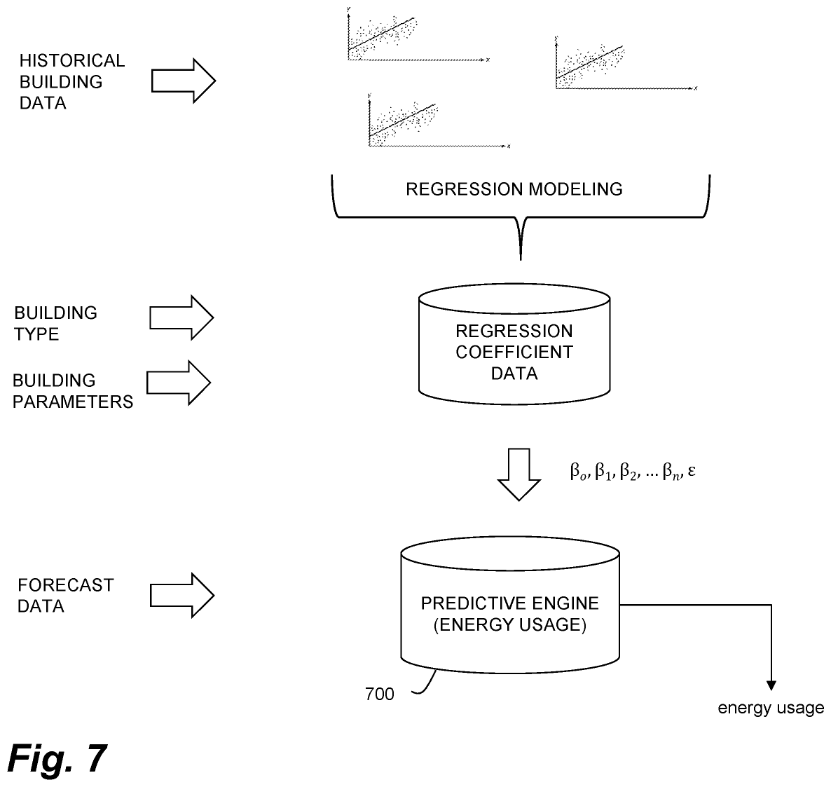

The method 400 may also or instead include generating, storing, and/or executing a second predictive engine 408 to simulate carbon production. In general, the second predictive engine 408 may be configured (e.g., by computer executable code executing on the central computing platform) to predict carbon production from the facility based on the building type for the facilities, as obtained from the classification engine 404, along with any other suitable model parameters, descriptive data, forecast data, or the like. In one aspect, the second predictive engine 408 may include a supervised machine learning model trained using historical carbon production data for the building type, along with temporally corresponding historical meteorological conditions. The second predictive engine 408 may be periodically updated on any useful schedule as new information becomes available. A suitable second predictive engine 408 is described by way of non-limiting example with reference to FIG. 7 below.

As shown in step 410, the method 400 may include receiving a user request 410, such as by receiving user input(s) to a user interface for the central computing platform. For example, this may include receiving a request for a carbon offset estimate for a user-selected facility over an interval. This may, for example, include receiving user input in a user interface for the central computing platform specifying a time interval for simulation and analysis. In one aspect, this may include a long-term interval (e.g., months or years) to facilitate an evaluation of whether to add renewable energy resources to an existing facility. In another aspect, this may include a short-term interval (e.g., days or weeks) to facilitate tactical decisions on carbon budgets and possible remediations for same.

As shown in step 412, the method 400 may include, in response to the user request, retrieving forecast data 402, e.g., by programmatically accessing various external data sources from the central computing platform. For example, this may include retrieving meteorological forecast data for the interval from remotely hosted resources.

As shown in step 414, the method may include, in response to the user request, executing the classification engine 404 to determine a building type for the facility. For example, this may include processing descriptive data for the facility with the classification engine 404 to calculate the building type for the facility with a k-nearest neighbor model or other trained model or the like that is configured to classify the building type based on objective data including or derived from data such as a building size, a building usage, and a location profile for the building. More generally, any one or more types of descriptive data for a facility that can be correlated to building type may be used by the classification engine 404 as object data to calculate a type of building.

As shown in step 416, the method 400 may include simulating a renewable energy output for the facility over the interval with the first predictive engine 406 based on the meteorological prediction data for the interval. This may, for example, include simulating a renewable energy generation from a renewable energy source (real or hypothetical) that is colocated with the facility using the first predictive engine 406. The first predictive engine may usefully calculate energy generation using, e.g., a predictive model trained to estimate an output for a renewable resource type based on one or more result effective variables and a physics model to adjust an output of the predictive model according to one or more objective features of the renewable resource type. In this manner, general behaviors for a type of renewable energy system, in response to meteorological conditions, can be simulated using the predictive model. The output from this simulation can then be scaled or otherwise fine-tuned according to particular, known details of the particular system of interest. Thus for example, the simulation may be used to model electrical output from a single solar panel, and then the physical model may be used to scale this electrical output according to the dimensions of the solar panel, or according to the number of solar panels in a particular installation.

As shown in step 418, the method 400 may include simulating a carbon output for the facility over the interval with the second predictive engine 408 based on the building type from the classification engine 404 and the meteorological prediction data from the forecast data 402 for the interval. As described herein, the second predictive engine 408 may calculate the carbon production using a simulation based on the meteorological prediction data for the user-specified interval and a supervised machine learning model trained using historical carbon production data for the building type and temporally corresponding historical meteorological conditions.

As shown in step 420, the method 400 may include calculating a carbon offset estimate responsive to the user request. In general, the carbon offset estimate may represent a difference between a target for net carbon emissions and an expected net carbon emissions based on the simulation output. For example, this may more specifically include calculating the carbon offset estimate based on a difference between the renewable energy output (simulated with the first predictive engine 406) and the carbon output (simulated with the second predictive engine) over the interval specified by the user.

This may also include acquiring additional data to refine offset calculations. For example, in one aspect, the method 400 may include instrumenting the facility with a first one or more sensors to monitor a current energy generation from the at least one colocated renewable energy source at the facility. The method 400 may also or instead include instrumenting the facility with a second one or more sensors to monitor a current electrical consumption at the facility. Based on this instrumentation, calculations of carbon offset as described herein may include acquiring data from one or more sensors at the facility to monitor a current energy generation from the at least one colocated renewable energy source, and updating the carbon offset estimate for the interval based on the current energy generation. The calculations may also or instead include acquiring data from one or more sensors at the facility to monitor a current electrical consumption at the facility, and updating the offset estimate for the interval based on the current electrical consumption. In this manner, simulation results may advantageously be refined with real time data from the facility as it becomes available. This also permits continuous monitoring, e.g., to evaluate whether actual results are converging on or deviating from simulated results obtained from the predictive engines based on forecast data.

As shown in step 422, the method 400 may include taking one or more responsive actions, e.g., based on the carbon offset estimate. For example, this may include comparing the carbon offset estimate for the facility to a carbon target for the facility, e.g., by calculating a difference between the carbon offset estimate and the carbon target, and responsively generating a user recommendation for possible remediations. In another aspect, this may include providing a variety of related user interactions. For example, this may include displaying a comparison of the carbon offset estimate to the carbon target for the facility in a user interface such as the user interface hosted by the central computing platform. This may also or instead include updating the carbon offset estimate for the interval based on data from the sensors, either during or after the interval, and presenting the updated carbon offset estimate to a user. Other actions may include automatic remediations, or recommendations for user remediations. For example, taking an action may include transmitting a request for a responsive action from a user to a difference between the carbon offset estimate and a carbon target for the facility during the interval. Taking an action may also or instead include generating an automated action to reduce the carbon offset estimate. In this manner, automated or manual remediations may be managed in response to predicted offsets, and/or in response to changes in a predicted offset as real time data is acquired from the facility.

In another aspect, taking an action may include aggregating sensor data from the facility, such as data from environmental monitors, device monitors, and other sensors and monitoring devices providing data to the central computing platform. This data may generally be normalized and aggregated to support downstream processing such as peer benchmarking, training of machine learning models, and so forth.

According to the foregoing, there is also disclosed herein a system for predictive analysis of carbon budget data based on third-party services and a local facility classification engine. The system may include a physical site including a building, a renewable energy source, and a plurality of sensors for monitoring energy usage at the building. The system may also include a database storing data acquired from the plurality of sensors, and a server hosting renewable energy management resources for the physical site. The renewable energy management resources may include: a programmatic interface to a remote service configured to provide meteorological prediction data, a classification engine configured to categorize a building type using a k-nearest neighbor model based on objective building parameters, a first predictive engine configured to simulate renewable energy generation from the renewable energy source using a predictive model trained to apply result effective variables to estimate an output for a renewable resource type and a physics model to adjust the output according to one or more objective features of the renewable resource type, and a second predictive engine configured to simulate a carbon production from the physical site based on at least the meteorological prediction data and the building type, the second predictive engine using a supervised machine learning model trained using historical carbon production data for the building type and temporally corresponding historical meteorological conditions. The server may be configured to receive, in a user interface rendered by the server, an input of an interval for processing carbon data for the physical site, retrieve, through the programmatic interface to the remote service, the meteorological prediction data for the interval identified in the input, determine, with the classification engine, the building type associated with the physical site, calculate, with the first predictive engine, an expected output during the interval from the renewable energy source colocated with the physical site, calculate, with the second predictive engine, an expected carbon production during the interval from the physical site, and initiate, in response to a disparity between the expected output of the renewable source and the expected carbon production of the physical site, a responsive action for the physical site.

In one aspect, the responsive action may include an automatic action by the server to reduce the disparity. In another aspect, the responsive action includes transmitting a notification concerning the disparity to an administrator. The renewable energy source may include a solar power source, a wind turbine, and/or any of the other renewable energy sources described herein.

FIG. 5 illustrates a process for generating a classification engine. In general, the classification engine 500, which may be any of the classification engines described herein, may be trained to perform classification tasks in order to select a suitable simulation model. For example, the classification engine 500 may be a machine learning model trained using a k-nearest neighbor model to classify different types of buildings.

In order to train a nearest neighbor model to classify types of buildings, a labeled dataset may be created. For example, the labeled dataset may include features (e.g., “building parameters”) or feature sets for buildings, which may be labeled with corresponding building types. A nearest neighbor model generally uses a distance metric to find the most similar instances of an item (e.g., building type) in the training set and assigns labels based on these similarities. For a dataset of buildings, relevant features may include, e.g., building height, number of floors, total area, construction materials, architectural style, etc. The labels will be the types of buildings (e.g., residential, commercial, industrial). It will also be understood that the parameters used for training the model may include feature vectors that characterize, summarize, abstract, normalize, or otherwise preprocess raw data characterizing various building types. When the parameters used for training the model are preprocessed into feature vectors or the like, it will be understood that the resulting classification engine will receive inputs that are similarly preprocessed into feature vectors for purposes of classifying a building type.

The dataset may be divided into a training set and a testing set, and a suitable distance metric may be selected. For example, this may include a Euclidean distance, a Manhattan distance, a Minkowski distance, or any other suitable distance measure. For the two-dimensional feature set shown in FIG. 5, a Euclidean distance may be used, and may usefully divide the attribute space into classification regions for each building type. The resulting model is depicted as a cluster map in FIG. 5, which yields a simple type lookup across the attribute space. For a particular attribute space, including more complex, multi-dimensional attributes spaces, computer tools are available, such as a Python scikit-learn library, which can be used to create a nearest neighbor classifier based on the number of neighbors (k) and the selected distance metric.

The resulting classification function can then be tested and refined as necessary. This may, for example, include adjusting the distance metric or using a weighted nearest neighbor approach. The resulting model may be deployed as the classification engine 500, e.g., as an executable model on the central computing platform, where the classification engine 500 may be executed to receive building parameters for a new building, and return a building type based on the input parameters, subject to any confidence metrics or other outputs that may be provided by the model.

It will be understood that a k-nearest neighbor classification will generally be based on the particular distance function, classification categories, and attribute space, and may not always yield a clear binary decision. As such, an accuracy or confidence level may also be reported, and may be useful in downstream classifications provided by the classification engine 500. In the context of the simulations described herein, two or more results with high confidence may require special handling. For example, if the classification engine 500 were to return two building types, each with a 48% chance of being correct, the system may provide a default decision rule, e.g., in favor of a particular building type, or the system may support blended simulation results, e.g., by performing simulations for two or more different building types and calculating a weighted average of the results for each type based on the probability or confidence in the accuracy of each individual classification.

FIG. 6 illustrates a process for generating a predictive engine. In general, the predictive engine 600, which may be any of the predictive engines described herein, may be trained to perform simulations that predict results based on data projections from other sources. For example, the predictive engine 500 may be a supervised learning model trained using regression or other supervised learning techniques to correlate input data (such as forecast data) with renewable energy generation. The results of the supervised learning model may also be scaled using a physical model to adjust the predicted results according to known physical attributes of a renewable energy system.

In one aspect, a supervised learning model as described herein may be trained to predict renewable energy output based on weather forecasts available from various meteorological forecasting resources, such as the external data sources described herein. In order to train this model, a dataset may initially be gathered containing, e.g., historical weather data and corresponding renewable energy output (e.g., solar or wind). Weather data may include temperature, humidity, wind speed, wind direction, cloud cover, precipitation, solar irradiance, and so forth, e.g., over an interval used for modeling. Renewable energy output may be renewable energy generation by renewable energy systems of the same interval, and may be reported in any suitable units including, e.g., dollar value, British Thermal Units (BTUs), Watt-hours (e.g., Kilowatt-hours, Megawatt-hours, or the like), or any other suitable units or combination of units suitable for use in carbon budgeting as described herein. The dataset may usefully be preprocessed to handle missing values, normalize numerical features, encode categorical variables, provide feature vectors, and so forth. In general, the dataset may be divided into a training set and a testing set, in order to evaluate the performance of the resulting model.

In one aspect, generating the predictive engine may include selecting a suitable supervised learning model. A variety of supervised learning models are known in the art, and may be adapted for predicting renewable energy based on weather data, such as linear regression, decision trees, random forests, support vector machines, and neural networks. While the choice of model will depend on the nature of the underlying data, a regression model has been demonstrated to usefully relate weather patterns to renewable energy generation. Random Forest is also an effective ensemble machine learning algorithm useful for regression predictive modeling problems, and may be used in this context to predict time series data. The selected learning model may then be trained on the training dataset, and tested (e.g., based on mean square error, coefficient of determination, or other measures of fit to test data) with the testing dataset. Where performance is unsatisfactory, the model may be tuned or replaced, e.g., by changing supervised learning models, tuning hyperparameters (e.g., learning rate, number of hidden layers, etc.), feature engineering (extracting and transforming relevant features from raw data), and so forth to improve the results.

For purposes of scaling outputs, the predictive engine 600 may also include a physical model that incorporates system parameters useful for scaling results of the supervised learning model. This may include current system attributes for the renewable energy system, e.g., size, capacity, efficiency, age, and/or any other relevant factor(s) that may influence the energy output. This may advantageously simplify modeling by permitting the use of a generic model for a particular type of renewable energy generation (e.g., solar) that can be scaled according to the size, location, and other features of a particular installation.

After creating a satisfactory model, the predictive engine 600 may be deployed as an executable model, e.g., on the central computing platform. The executable model may generally receive forecast data such as meteorological prediction data and return renewable energy output for a renewable energy system. It will be understood that, while a single model is described, the predictive engine 600 may usefully employ different models for different renewable energy types including, e.g., specific models for solar energy, wind energy, geothermal energy, hydroelectric energy, biomass energy, tidal energy, wave energy, and so forth. In this case, any initial step in executing the predictive engine 600 may include selecting a renewable energy type in order to facilitate identification and use of an appropriate renewable energy predictive model.

FIG. 7 illustrates a process for generating a predictive engine. In general, the predictive engine 700, which may be any of the predictive engines described herein, may be trained to perform simulations that predict results based on data projections from other sources. For example, the predictive engine 500 include a number of supervised learning models, each trained using regression or other supervised learning techniques to correlate input data (such as forecast data) with energy usage for a particular building type. In this case, an initial selection of a building type (e.g., using one of the classification engines described herein) may be performed to support selection of a corresponding model (or specific regression coefficients or the like for a model) to use in predicting energy usage.

In one aspect, a collection of supervised learning models may be trained to predict energy usage based on weather forecasts available from various meteorological forecasting resources, such as the external data sources described herein. In order to train these models, a dataset may initially be gathered containing, e.g., historical weather data and corresponding renewable energy output (e.g., solar or wind) over an interval of interest, along with building energy usage (and corresponding building type) over the same interval. The weather data may include temperature, humidity, wind speed, wind direction, cloud cover, precipitation, solar irradiance, and so forth. The dataset may usefully be preprocessed to handle missing values, normalize numerical features, encode categorical variables, provide feature vectors, and so forth.

In one aspect, generating the predictive engine may include selecting a suitable supervised learning model. A variety of supervised learning models are known in the art, and may be adapted for predicting energy usage for a building type based on weather data, such as linear regression, decision trees, random forests, support vector machines, and neural networks. While the choice of model will depend on the nature of the underlying data, a regression model has been demonstrated to usefully relate weather patterns to energy usage for various building types. Random Forest is also an effective ensemble machine learning algorithm useful for regression predictive modeling problems, and may be used in this context to predict time series data. The selected learning model may then be trained on the training dataset for each building type, and tested (e.g., based on mean square error, coefficient of determination, or other measures of fit to test data). Where performance is unsatisfactory, each model may be tuned or replaced, e.g., by changing supervised learning models, hyperparameter tuning, feature engineering, and so forth.

After creating a satisfactory model (or group of models, e.g., with one for each building type), the predictive engine 700 may be deployed as an executable model, e.g., on the central computing platform. The executable model may generally receive forecast data such as meteorological prediction data, along with a building type (e.g., from the classification engine) and any suitable building parameters, and return a predicted energy usage for the building (or other facilities). It will be appreciated that, in this context, energy usage may be measured in a variety of ways. For example, this may include electrical consumption, natural gas or oil consumption (e.g., for local heating, electricity generation, hot water, etc.), utilities usage, and so forth. In general, the units of measurement for energy usage will be selected to facilitate comparison to the renewable energy generation, e.g., in order to facilitate calculations of carbon budgets or carbon offsets, and to facilitate predictions and evaluations of whether current carbon targets are likely to be achieved, or whether remedial measures might be required. In certain cases, this may require conversion of predicted energy usage into alternative measures, such as the dollar cost of energy usage (e.g., for comparison to the value of renewable energy production). In one aspect, energy usage may be converted into a measure of carbon output, e.g., for direct use in carbon budgeting, carbon remediation calculations, carbon emissions targeting, and so forth. In another aspect, the energy usage may be an aggregated energy usage for all resources at a facility including, e.g., utilities, electricity, natural gas, oil, etc., along with any offsetting factors such as local electricity storage facilities or the like.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from same.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as described herein.

What is claimed is:

1. A predictive analytics system for resource management at a facility with at least one colocated renewable energy source, the system including computer executable code stored in a non-transitory computer readable medium that, when executing on one or more computing devices, causes the one or more computing devices to perform the steps of:
executing a classification engine to identify a building type, the classification engine applying a k-nearest neighbor model configured to categorize a building type based on at least a building size, a building usage, and a location demographic profile;
executing a first predictive engine to predict renewable energy generation from the at least one colocated renewable energy source based on meteorological data, the first predictive engine using a predictive model trained to apply result effective variables to estimate an output for a renewable resource type and a physics model to adjust the output according to one or more objective features of the renewable resource type;
executing a second predictive engine to predict carbon production from the facility based on the building type, the second predictive engine using a supervised machine learning model trained using historical carbon production data for the building type and temporally corresponding historical meteorological conditions;
receiving a request for a carbon offset estimate for the facility over an interval;
retrieving meteorological prediction data for the interval from one or more remotely hosted meteorological services;
determining the building type for the facility with the classification engine;
simulating a renewable energy output for the facility over the interval with the first predictive engine based on the meteorological prediction data for the interval;
simulating a carbon output for the facility over the interval with the second predictive engine based on the building type from the classification engine and the meteorological prediction data for the interval;
calculating the carbon offset estimate based on a difference between the renewable energy output and the carbon output over the interval; and
taking an action based on the carbon offset estimate.

2. The predictive analytics system of claim 1, further comprising code that performs the step of comparing the carbon offset estimate for the facility to a carbon target for the facility, and generating a user recommendation based on a difference between the carbon offset estimate and the carbon target.

3. The predictive analytics system of claim 1, further comprising code that performs the steps of acquiring data from one or more sensors at the facility to monitor a current energy generation from the at least one colocated renewable energy source, and updating the carbon offset estimate for the interval based on the current energy generation.

4. The predictive analytics system of claim 1, further comprising code that performs the steps of acquiring data from one or more sensors at the facility to monitor a current electrical consumption at the facility, and updating the offset estimate for the interval based on the current electrical consumption.

5. The predictive analytics system of claim 1, wherein the colocated renewable energy source includes at least one of a solar power source or a wind turbine.

6. A method for predictive analysis of carbon budgets for a facility with at least one colocated renewable energy source, the method comprising:
receiving a request for a carbon offset estimate for the facility over an interval;
retrieving meteorological prediction data for the interval from one or more remotely hosted meteorological services;
processing building data for the facility with a classification engine to determine the building type for the facility, where the classification engine applies a k-nearest neighbor model configured to categorize the building type based on the building data, and wherein the building data includes at least a building size, a building usage, and a location demographic profile;
simulating a renewable energy generation from the at least one colocated renewable energy source with a first predictive engine, the first predictive engine calculating energy generation using (a) a predictive model trained to estimate an output for a renewable resource type based on one or more result effective variables and (b) a physics model to adjust an output of the predictive model according to one or more objective features of the renewable resource type;
simulating a carbon production from the facility with a second predictive engine, the second predictive engine calculating the carbon production using the meteorological prediction data for the interval and a supervised machine learning model trained using historical carbon production data for the building type and temporally corresponding historical meteorological conditions;
calculating the carbon offset estimate based on a difference between the renewable energy output and the carbon output over the interval; and
taking an action based on the carbon offset estimate.

7. The method of claim 6, further comprising comparing the carbon offset estimate for the facility to a carbon target for the facility.

8. The method of claim 6, further comprising displaying a comparison of the carbon offset estimate to the carbon target for the facility in a user interface.

9. The method of claim 6, further comprising:
instrumenting the facility with a first one or more sensors to monitor a current energy generation from the at least one colocated renewable energy source at the facility; and
instrumenting the facility with a second one or more sensors to monitor a current electrical consumption at the facility.

10. The method of claim 9, further comprising updating the carbon offset estimate for the interval based on data from the first one or more sensors and the second one or more sensors during the interval.

11. The method of claim 10, further comprising presenting the updated carbon offset estimate to a user.

12. The method of claim 9, further comprising normalizing and aggregating sensor data from the second one or more sensors for use in at least one of peer benchmarking and machine learning.

13. The method of claim 9, wherein the second one or more sensors include one or more device monitors within the facility.

14. The method of claim 6, wherein taking an action includes transmitting a request for a responsive action from a user to a difference between the carbon offset estimate and a carbon target for the facility during the interval.

15. The method of claim 6, wherein taking an action includes generating an automated action to reduce the carbon offset estimate.

16. The method of claim 6, wherein the one or more result effective variables for the predictive model include at least one variable from the meteorological prediction data.

17. A system for predictive analysis of carbon budget data based on third-party meteorological services and a local facility classification engine, the system comprising:
a physical site including a building, a renewable energy source, and a plurality of sensors for monitoring energy usage at the building;
a database storing data acquired from the plurality of sensors; and
a server hosting renewable energy management resources for the physical site,
the renewable energy management resources including:
a programmatic interface to a remote service configured to provide meteorological prediction data,
a classification engine configured to categorize a building type using a k-nearest neighbor model based on objective building parameters,
a first predictive engine configured to simulate renewable energy generation from the renewable energy source using a predictive model trained to apply result effective variables to estimate an output for a renewable resource type and a physics model to adjust the output according to one or more objective features of the renewable resource type, and
a second predictive engine configured to simulate a carbon production from the physical site based on at least the meteorological prediction data and the building type, the second predictive engine using a supervised machine learning model trained using historical carbon production data for the building type and temporally corresponding historical meteorological conditions,
and the server configured to
receive, in a user interface rendered by the server, an input of an interval for processing carbon data for the physical site,
retrieve, through the programmatic interface to the remote service, the meteorological prediction data for the interval identified in the input,
determine, with the classification engine, the building type associated with the physical site,
calculate, with the first predictive engine, an expected output during the interval from the renewable energy source colocated with the physical site,
calculate, with the second predictive engine, an expected carbon production during the interval from the physical site, and
initiate, in response to a disparity between the expected output of the renewable source and the expected carbon production of the physical site, a responsive action for the physical site.

18. The system of claim 17, wherein the responsive action includes an automatic action by the server to reduce the disparity.

19. The system of claim 17, wherein the responsive action includes transmitting a notification concerning the disparity to an administrator.

20. The system of claim 17, wherein the renewable energy source includes at least one of a solar power source and a wind turbine.
